(19) United States
(12) Patent Application Publication
(10) Pub. No.: US 2006/0209469 A1
(43) Pub. Date: Sep. 21, 2006

(54) Magnetoresistance effect reproduction head

(75) Inventor: Hideyuki Akimoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/182,571

(22) Filed: Jul. 15, 2005

(30) Foreign Application Priority Data
Mar. 17, 2005 (JP) 2005-077478

(51) Int. Cl. G11B 5/33; G11B 5/127

(52) U.S. Cl. 360/319

(57) ABSTRACT

A magnetoresistance effect reproduction head includes a shield part composed of a lower shield and an upper shield and prevents fluctuations in head output caused by the magnetic domain structure of the magnetic shield layer, and therefore has a more stabilized head output. In a magnetoresistance effect reproduction head including a shield part that magnetically shields a magnetoresistance effect element, the shield part is formed with a polygonal planar form that is asymmetrical in a height direction.

### BACKGROUND OF THE INVENTION

1. Field of the Invention

The present invention relates to a magnetoresistance effect reproduction head and in more detail to a magnetoresistance effect reproduction head where a shield part provided therein has a characteristic structure.

2. Related Art

The increases in the amount of stored information in recent years have led to demands for higher recording densities for magnetic disk apparatuses. As the areal recording density is increased, the area occupied by one bit of information magnetically recorded on a recording medium decreases. A corresponding reduction is also made in the sensor size of a magnetoresistance effect reproduction head that reads the information magnetically recorded on the recording medium.

FIG. 11 schematically shows the positional relationship between a recording medium 5 and a magnetoresistance effect reproduction head in a state where magnetically recorded information is read from the recording medium. The magnetoresistance effect reproduction head is formed by sandwiching a magnetoresistance effect element 10 for reading the magnetically recorded information between a lower shield 12 and an upper shield 14. When reading the magnetically recorded information, the end surfaces of the magnetoresistance effect element 10, the lower shield 12, and the upper shield 14 are positioned facing the surface of the magnetic medium 5 and the information magnetically recorded on the magnetic medium 5 is read.

The lower shield 12 and the upper shield 14 act as a shield to prevent magnetism from bits aside from the bit presently being read from affecting the magnetoresistance effect element 10. This means that only the magnetically recorded information directly below the magnetoresistance effect element 10 is detected and the required resolution is achieved.

Conventionally, the lower shield 12 and the upper shield 14 are formed so as to be rectangular or square in planar form as shown in FIG. 11 when viewed from a direction perpendicular to the medium surface of the magnetic medium 5.

FIG. 12 shows the structure of a magnetoresistance effect reproduction head when viewed from the floating surface side of a head slider. In this magnetoresistance effect reproduction head, a spin-valve GMR element is shown as the magnetoresistance effect element 10. The spin-valve GMR element is formed by laminating an anti-ferromagnetic layer 101, a pinned layer 102, a free layer 103, and a capping layer 104. The anti-ferromagnetic layer 101 is anti-ferromagnetically coupled to the pinned layer 102 and acts so as to pin the magnetic direction of the pinned layer 102 in a “height” direction for the element (i.e., the direction perpendicular to the medium surface). The free layer 103 is a magnetic layer whose magnetic direction can be freely changed in accordance with the information magnetically recorded on a recording medium.

The spin-valve GMR element detects the information magnetically recorded on a recording medium by detecting changes in the resistance of the GMR element using an effect whereby the resistance changes depending on the angle of the magnetic direction of the pinned layer 102 and the free layer 103.

In FIG. 12, the magnetoresistance effect element 10 is disposed so as to be sandwiched in the thickness direction by the lower shield 12 and the upper shield 14 via insulating layers 16, 18. To improve the reproduction efficiency of the magnetoresistance effect element 10, a hard film 20 composed of a permanent magnet material is disposed on the sides of the magnetoresistance effect element 10. The hard film 20 acts so as to align the magnetic direction of the free layer 103 of the magnetoresistance effect element 10 in the core width direction when no magnetism acts from the recording medium. A magnetic material such as Co with a comparatively large magnetic coercive force is used as the hard film 20.

As the manufacturing process of a magnetoresistance effect reproduction head including the hard film 20 for controlling the magnetic domain of the free layer 103 of the magnetoresistance effect element 10 as described above, there is a process that magnetizes the hard film 20 by applying a magnetic field of around 5 kOe in the core width direction to align the magnetic direction of the hard film 20 in the core width direction. In this magnetizing process, the magnetic direction of the magnetic body composing the magnetoresistance effect reproduction head is temporarily oriented in the magnetizing direction and the magnetic directions of the respective parts when the magnetizing magnetic field is removed are as follows. The magnetic direction of the hard film 20 substantially matches the magnetizing direction and the magnetic direction of the free layer 103 substantially matches the magnetizing direction due to the bias magnetic field of the hard film 20. Due to the action of the anti-ferromagnetic layer 101 however, the magnetic direction of the pinned layer 102 remains the “height” direction for the element irrespective of the magnetizing direction.

On the other hand, since the lower shield 12 and the upper shield 14 are formed of soft magnetic bodies whose magnetic coercive force is extremely small, the magnetizing patterns of the layers 12 and 14 are constructed so that the magnetostatic energy is minimized when the magnetizing magnetic field has been removed. That is, when viewed as a whole, the lower shield 12 and the upper shield 14 form a magnetic domain structure where the overall magnetism is substantially zero. In other words, the magnetic domain structure of the lower shield 12 and the upper shield 14 after the magnetizing magnetic field has been removed is a closure domain structure such as the clockwise domain shown in FIG. 13A or the counter-clockwise domain shown in FIG. 13B.

When the lower shield 12 and the upper shield 14 are magnetized, the magnetic direction matches the orientation of the magnetizing magnetic field, but after the magnetizing magnetic field has been removed, it is indefinite whether a clockwise magnetic domain structure or a counter-clockwise magnetic domain structure will be produced. Since the lower shield 12 and the upper shield 14 exhibit left-right symmetry, the clockwise magnetic domain structure and the counter-clockwise magnetic domain structure have equal probabilities, with incidences of clockwise magnetic domain structures and incidences of counter-clockwise magnetic domain structures appearing substantially equally.

While the core widths of the lower shield 12 and the upper shield 14 are several tens to one hundred microns and the heights are several tens of microns, the core width and sensor height of the magnetoresistance effect element 10 are both around 100 nm, so that the magnetoresistance effect element 10 is far smaller than the shield layers (several hundred to one thousand times smaller).

This means that when the shield layers are viewed from the magnetoresistance effect element 10, the clockwise magnetic domain structure shown in FIG. 13A is the equivalent of a structure that magnetizes uniformly in the counter-clockwise direction and the counter-clockwise magnetic domain structure shown in FIG. 13B is the equivalent of a structure that magnetizes uniformly in the clockwise direction.

In the magnetoresistance effect element 10 which is a GMR element or the like, as shown in FIGS. 14A and 14B, due to the formation of a current element 22 on both sides of the magnetoresistance effect element 10 or the like, the upper shield 14 is convex downward (toward the magnetoresistance effect element 10) near the upper surface of the magnetoresistance effect element 10. In this way, when a convex part is formed in the upper shield 14, as described above, when the upper shield 14 is magnetized in a leftward direction or a rightward direction, magnetic charge is produced at the interface where the upper shield 14 protrudes downward, so that the magnetic fields shown by the broken lines in the drawings are produced for the magnetoresistance effect element 10.

FIG. 14A shows the state where the upper shield 14 is effectively magnetized in the leftward direction, and in this case, the magnetic field produced by the convex part of the upper shield 14 is produced in an inverse direction to the bias magnetic field that acts in the core width direction due to the hard film 20, and therefore acts so as to reduce the bias magnetic field. On the other hand, when the upper shield 14 is effectively magnetized in the rightward direction, the magnetic field produced by the convex part of the upper shield 14 is produced in the same direction as the bias magnetic field due to the hard film 20, and therefore acts so as to increase the bias magnetic field.

In this way, with the conventional magnetoresistance effect reproduction head, the bias magnetic field that acts on the magnetoresistance effect element 10 effectively fluctuates according to whether the upper shield 14 has a clockwise structure or a counter-clockwise structure. The angle by which the free layer 103 rotates with respect to the magnetic field of the recording medium also fluctuates due to the fluctuation in the bias magnetic field, and this results in the problem of fluctuations in the output of the magnetoresistance effect reproduction head.

### SUMMARY OF THE INVENTION

It is an object of the present invention to provide a magnetoresistance effect reproduction head and a magnetic disk apparatus that uses the same. The magnetoresistance effect reproduction head includes a shield part composed of a lower shield and an upper shield and prevents fluctuations in head output caused by the magnetic domain structure of the shield part, resulting in a more stabilized head output and an improved manufacturing yield due to the fluctuations between products being suppressed.

To achieve the stated object, a magnetoresistance effect reproduction head according to the present invention includes a shield part that magnetically shields a magnetoresistance effect element, wherein the shield part is formed with a polygonal planar form that is asymmetrical in a height direction. It should be noted that the expression “asymmetrical in a height direction” means that the shield part is asymmetrical about an imaginary line of symmetry that is parallel with the height direction.

The expression “shield part” here refers to a lower shield and an upper shield disposed on either side of a magnetoresistance effect element in the thickness direction. Both the lower shield and the upper shield may be asymmetrical, or one of the lower shield and the upper shield, preferably only the upper shield, should be asymmetrical.

The shield part may be formed so as to be trapezoidal where an upper end surface in the height direction is inclined, so that the shield part can be easily made symmetrical.

By setting an angle of inclination θ of the upper surface of the shield part in a range of 10 to 45°, inclusive, and setting a length of the shield part in the height direction in a range of ⅕ to ⅔, inclusive, of a length of the shield part in a core width direction, the magnetic domain structure of the shield part after the magnetizing magnetic field has been removed can be uniquely determined.

Another magnetoresistance effect reproduction head according to the present invention includes a shield part that magnetically shields a magnetoresistance effect element, wherein the shield part is formed with a polygonal planar form that is asymmetrical in a core width direction.

By forming the shield part so as to be trapezoidal where side surfaces along a height direction are formed as inclined surfaces, it is possible to uniquely determine the magnetic domain structure of the shield part easily.

The shield part may also be characterized by forming the shield part with an isosceles trapezoidal planar form, by setting a flare angle a of the side surfaces along the height direction of the shield part in a range of 10 to 45°, inclusive, by setting a height (H) of the shield part in the height direction at one to three times a width (Wb) of the shield part in the core width direction, and by setting a flare angle α of one side surface along the height direction of the shield part at 0°.

A magnetic disk apparatus according to the present invention includes a magnetic recording disk that is rotationally driven by rotational driving means, support means including a head suspension and a carrier arm that support a head slider on which a recording/reproduction head is formed, and a control unit that drives the support means to cause the head slider to carry out a seek operation, wherein the recording/reproduction head includes, as a reproduction head, a magnetoresistance effect reproduction head including a shield part that magnetically shields a magnetoresistance effect element, wherein the shield part is formed with a polygonal planar form that is asymmetrical in a height direction.

The recording/reproduction head may alternatively include, as the reproduction head, a magnetoresistance effect reproduction head including a shield part that magnetically shields a magnetoresistance effect element, wherein the shield part is formed with a polygonal planar form that is asymmetrical in a core width direction.

With the magnetoresistance effect reproduction head according to the present invention, the magnetic domain structure that appears in the shield part due to a magnetizing process during the manufacturing of a reproduction head can be uniquely determined as a specified magnetic domain structure with a counter-clockwise or clockwise closure domain structure. By doing so, the bias magnetic field that acts on the magnetoresistance effect element that composes the magnetoresistance effect reproduction head can be fixed, and as a result, it is possible to provide a magnetoresistance effect reproduction head with a stable head output where fluctuations in the head output are prevented. In addition, by suppressing the fluctuations in the head output, it is possible to improve the manufacturing yield.

With the magnetic disk apparatus according to the present invention, by using a magnetoresistance effect reproduction head with a stabilized head output in the recording/reproduction head, it is possible to provide a highly reliable magnetic disk apparatus.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a perspective view schematically showing the construction of a lower shield and an upper shield according to a first embodiment of a magnetoresistance effect reproduction head according to the present invention;

FIG. 2 is a diagram useful in explaining a magnetic domain structure of a shield part;

FIGS. 3A and 3B are diagrams useful in explaining other examples of magnetic domain structures of a shield part;

FIG. 4 is a diagram useful in explaining a shield part whose planar form is trapezoidal;

FIG. 5 is a diagram useful in explaining another example of a shield part according to the first embodiment;

FIG. 6 is a perspective view schematically showing the construction of a lower shield and an upper shield according to a second embodiment of a magnetoresistance effect reproduction head according to the present invention;

FIG. 7 is a diagram useful in explaining a magnetic domain structure of a shield part;

FIGS. 8A and 8B are diagrams useful in explaining other examples of a magnetic domain structure of a shield part;

FIG. 9 is a diagram useful in explaining a shield part whose planar form is isosceles trapezoidal;

FIG. 10 is a diagram useful in explaining another example of a shield part;

FIG. 11 is a perspective view schematically showing the construction of a lower shield and an upper shield of a conventional magnetoresistance effect reproduction head;

FIG. 12 is a diagram useful in explaining the cross-sectional structure of the conventional magnetoresistance effect reproduction head;

FIGS. 13A and 13B are diagrams useful in explaining magnetic domain structures of a shield part of the conventional magnetoresistance effect reproduction head;

FIGS. 14A and 14B are diagrams useful in explaining the action of the shield part on a magnetoresistance effect reproduction element;

FIG. 15 is a plan view of a magnetic disk apparatus equipped with the magnetoresistance effect reproduction head according to the present invention; and

FIG. 16 is a perspective view of a head slider on which the magnetoresistance effect reproduction head according to the present invention is mounted.

### DESCRIPTION OF THE PREFERRED EMBODIMENTS

Preferred embodiments of a magnetoresistance effect reproduction head according to the present invention will now be described in detail with reference to the attached drawings.

### First Embodiment

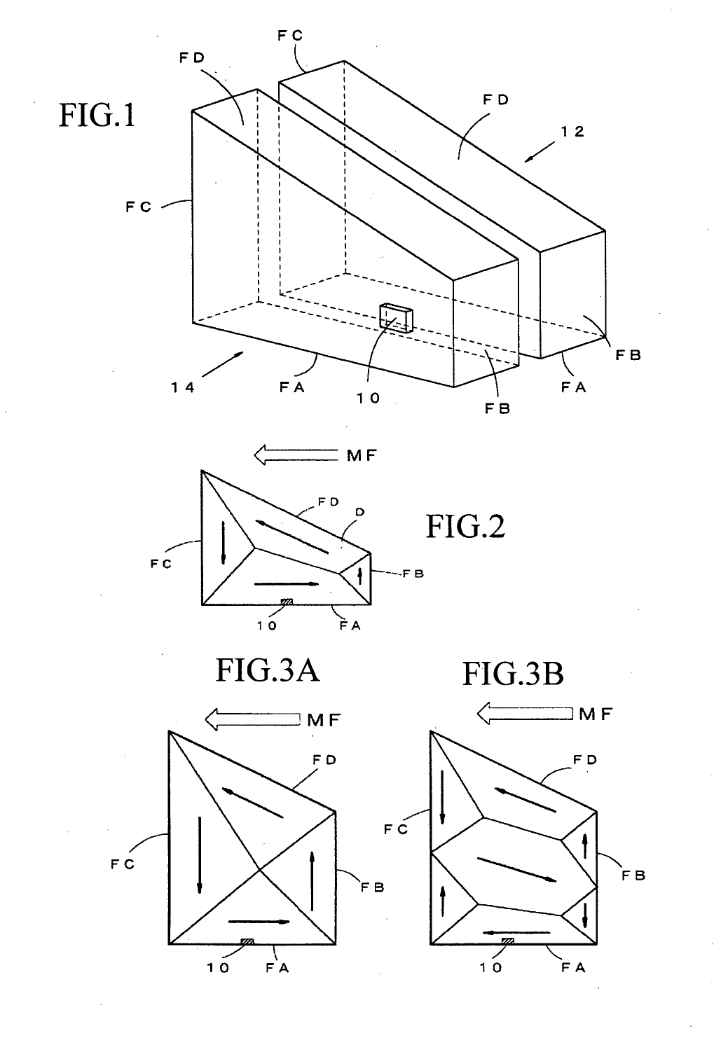

FIG. 1 is a perspective view showing the lower shield 12 and the upper shield 14 whose shapes are characteristic to the magnetoresistance effect reproduction head according to the present invention, as well as the magnetoresistance effect element 10. It should be noted that the structures of the laminated films composing the magnetoresistance effect element 10 and the structures of components composing the magnetoresistance effect reproduction head are fundamentally the same as magnetoresistance effect reproduction head described above. Accordingly, description thereof has been omitted below.

The most characteristic parts of the magnetoresistance effect reproduction head according to the present embodiment are the planar shapes of the lower shield 12 and the upper shield 14 that form a shield part of the magnetoresistance effect reproduction head. That is, while the lower shield 12 and the upper shield 14 are formed with rectangular or square planar shapes in the conventional magnetoresistance effect reproduction head, the lower shield 12 and the upper shield 14 are formed with trapezoidal planar shapes in the magnetoresistance effect reproduction head according to the present embodiment.

It should be noted that in the present embodiment, the respective side surfaces of the lower shield 12 and the upper shield 14 have been given the following names to specify the side surfaces. That is, the side surfaces of the lower shield 12 and the upper shield 14 that face the floating surface are called the “lower end surfaces” FA, the side surfaces on one side in the height direction of the element are called the “first side surfaces in the height direction” FB, the side surfaces on the other side in the height direction of the element are called the “second side surfaces in the height direction” FC, and the surfaces opposite the lower end surfaces are called the “upper end surfaces” FD.

Normally, the recording/reproduction head incorporated on a head slider is ground from the floating plane side of the head slider to set the height of the recording/reproduction head. This means that the respective lower end surfaces FA of the lower shield 12 and the upper shield 14 are formed as flat surfaces that are parallel to the floating surface. In the magnetoresistance effect reproduction head according to the present embodiment, for both the lower shield 12 and the upper shield 14, the first side surface in the height direction FB and the second side surface in the height direction FC are perpendicular to the lower end surface FA and the upper end surface FD is inclined with respect to the lower end surface FA. That is, the angle between the lower end surface FA and the first side surface in the height direction FB is 90°, the angle between the lower end surface FA and the second side surface FC is 90°, the angle between the first side surface FB and the upper end surface FD is obtuse, and the angle between the second side surface FC and the upper end surface FD is acute.

FIG. 2 shows the magnetic domain structure after the lower shield 12 and the upper shield 14 in FIG. 1 have been magnetized and the magnetizing magnetic field has been removed. In FIG. 2, the symbol “MF” represents the direction of the magnetizing magnetic field. Since the lower shield 12 and the upper shield 14 are formed of soft magnetic material such as NiFe, when the magnetizing magnetic field MF has been applied, the lower shield 12 and the upper shield 14 are magnetized in the direction of the magnetizing magnetic field, but when the magnetizing magnetic field is removed, a closure domain structure appears where the overall remanent magnetization is substantially zero. The characteristic of the lower shield 12 and the upper shield 14 in the present embodiment is that by forming the lower shield 12 and the upper shield 14 with planar shapes that are asymmetrical in the left-right direction, the direction of the closure domain structure that appears in the lower shield 12 and the upper shield 14 is uniquely determined.

That is, when the magnetizing magnetic force MF is removed, magnetism that is oriented in the direction of the magnetizing magnetic force MF remains in magnetic domains D formed along the upper end surfaces FD of the lower shield 12 and the upper shield 14, so that a counter-clockwise magnetic domain structure appears as shown in the drawing as the closure domain structure. This counter-clockwise closure domain structure appears for the following reason. Due to the asymmetry in the planar shapes of the lower shield 12 and the upper shield 14, the probability of a clockwise closure domain structure being produced and the probability of a counter-clockwise closure domain structure being produced are not equal. That is, the probability of a counter-clockwise closure domain structure such as that shown in FIG. 2 being produced is higher due to the planar shapes of the lower shield 12 and the upper shield 14 and the direction of the magnetizing magnetic force MF.

In this way, by making the planar shapes of the lower shield 12 and the upper shield 14 asymmetrical in the height direction so that a counter-clockwise magnetic domain structure appears when the magnetizing magnetic force is removed, the magnetic domain structure of the upper shield 14 effectively becomes rightward magnetism for the magnetoresistance effect element 10. Accordingly, as shown in FIG. 14B, the upper shield 14 acts so as to increase the bias magnetic field of the hard film 20. Also, since the direction shown in FIG. 2 is uniquely determined for the magnetic domain structure of the upper shield 14, the bias magnetic field that acts on the magnetoresistance effect element 10 is no longer increased or decreased by the magnetic domain structure of the upper shield 14, so that the problem of fluctuations in the head output can be solved.

FIGS. 3A and 3B show the magnetic domain structure of the lower shield 12 and the upper shield 14 in a case where the height of the respective first side surfaces FB in the height direction has been set substantially equal to the length of the respective lower end surfaces FA (i.e., the length in the core width direction) of the lower shield 12 and the upper shield 14.

FIG. 3A shows an example of a counter-clockwise magnetic domain structure, while FIG. 3B shows an example of a different magnetic domain structure. In this way, when the height of the first side surfaces FB is increased, the planar shapes of the lower shield 12 and the upper shield 14 become closer to being symmetrical, so that there is a fall in the uniformity with which the direction of the magnetic domain structure appearing in the lower shield 12 and the upper shield 14 can be determined, with instances of the structures shown in FIGS. 3A and 3B both occurring.

FIG. 3A shows a case where rightward magnetism acts at the position of the magnetoresistance effect element 10, while FIG. 3B shows a case where leftward magnetism acts at the position of the magnetoresistance effect element 10. If the magnetic domain structure that appears in the lower shield 12 and the upper shield 14 is not uniquely determined as shown in FIGS. 3A and 3B so that magnetic fields of different directions act at the position of the magnetoresistance effect element 10, fluctuations are produced in the head output.

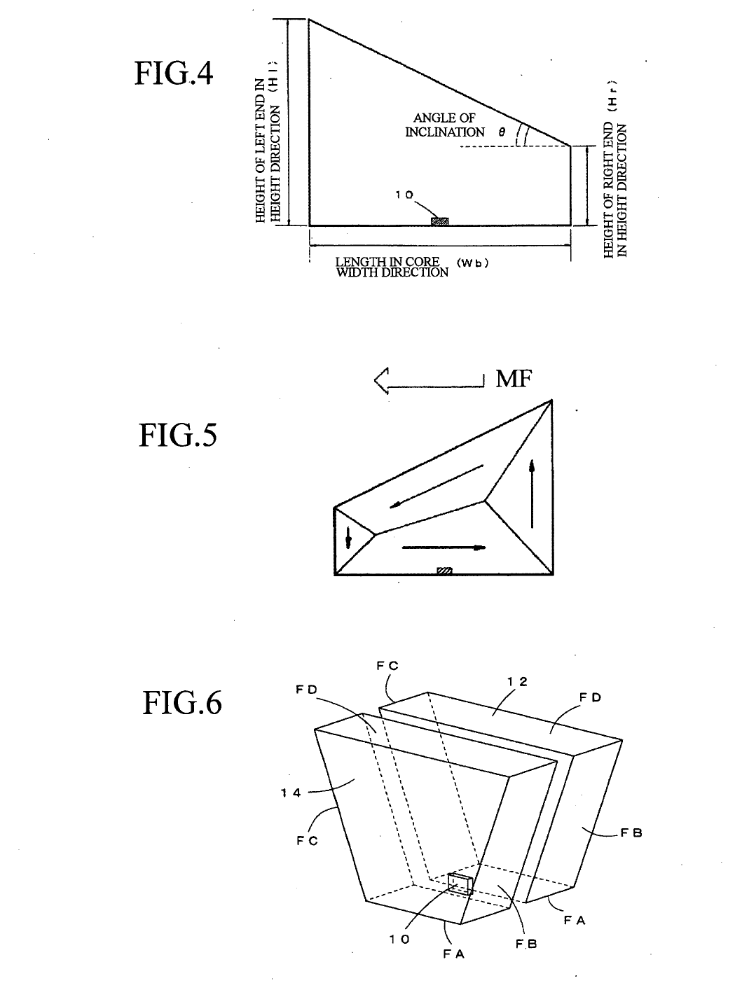

FIG. 4 is a plan view of the lower shield 12 and the upper shield 14 that compose the shield part. When the lower shield 12 and the upper shield 14 are formed so as to be trapezoidal, to uniquely determine the magnetic domain structure that appears in the lower shield 12 and the upper shield 14, the height (Hr) of the right sides in the height direction should be no more than ⅔ of the length in the core width direction (Wb).

It should be noted that if the height Hr of the right sides in the height direction is too low, it becomes no longer possible to produce a stabilized closure domain structure, so that the height Hr of the right sides in the height direction should preferable be around ⅕ of the length (Wb) in the core width direction or greater.

When the inclined angle θ of the upper end surfaces FD is 10° or below, there is insufficient left-right symmetry, while when the angle θ is 45° or above, a further magnetic domain appears in an upper triangular region, which changes the overall magnetic domain structure. Accordingly, the inclined angle θ of the upper end surfaces FD should be in a range of around 10 to 45°, inclusive.

Contrary to the method where the height Hr of the right side in the height direction is set lower than the height (Hl) of the left side in the height direction as shown in FIG. 4, it is also possible to set the height Hl of the right side in the height direction higher than the height H1 of the left side in the height direction as shown in FIG. 5. In this case also, when the magnetizing magnetic force MF is removed, a counter-clockwise magnetic domain structure appears as shown in FIG. 5.

It should be noted that when the orientation of the magnetizing magnetic force MF that acts on the lower shield 12 and the upper shield 14 is reversed, a clockwise magnetic domain structure appears in the lower shield 12 and the upper shield 14. Such clockwise magnetic domain structure can be used effectively when the orientation of the bias magnetic field of the hard film 20 that acts on the magnetoresistance effect element 10 is the reverse of the orientation shown in FIG. 14.

### Second Embodiment

FIG. 6 shows a second embodiment of a magnetoresistance effect reproduction head according to the present invention. The present embodiment is characterized by the planar shapes of the lower shield 12 and the upper shield 14 that form the shield part being formed as isosceles trapezoids. The lengths of the lower end surfaces FA (the lengths in the core width direction) of the lower shield 12 and the upper shield 14 are set shorter than the upper end surfaces FD.

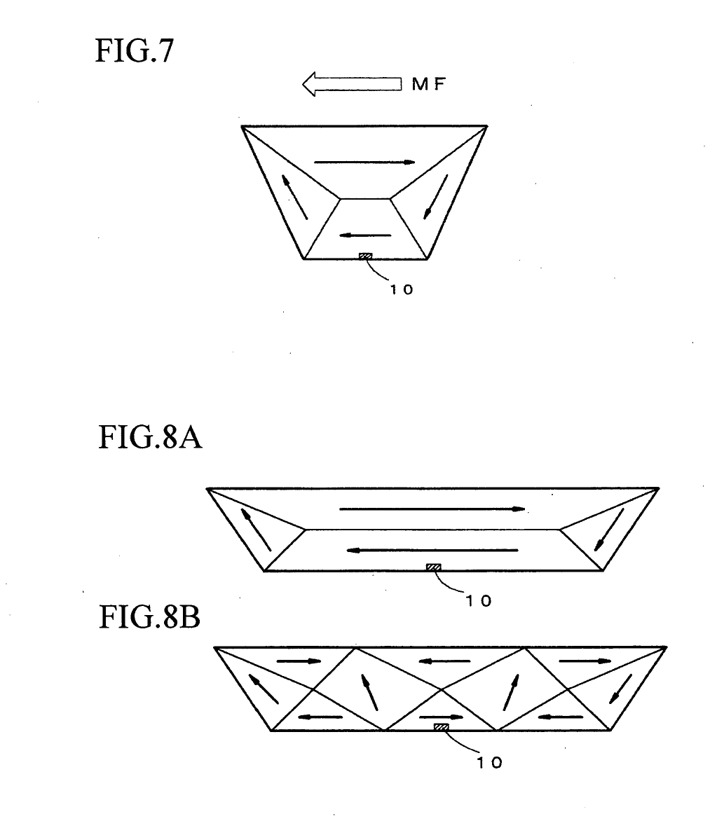

FIG. 7 shows the magnetic domain structure that appears in the lower shield 12 and the upper shield 14 whose planar shapes are isosceles trapezoids when the magnetizing magnetic force MF is first applied to the lower shield 12 and the upper shield 14 and then removed. As shown in FIG. 7, for the lower shield 12 and the upper shield 14 of the present embodiment, a clockwise magnetic domain structure appears in the lower shield 12 and the upper shield 14 due to the asymmetry of the lower shield 12 and the upper shield 14. Due to this magnetic domain structure, the magnetic domain structure of the upper shield 14 is equivalent to a state where leftward magnetism acts on the magnetoresistance effect element 10, so that the magnetic field shown in FIG. 14A acts on the magnetoresistance effect element 10.

FIG. 8A and FIG. 8B show magnetic domain structures in a state where the shapes of the lower shield 12 and the upper shield 14 are set so that the length (Wb) of the lower ends in the core width direction is around five times the height (H) in the height direction. In this way, when the length (Wb) of the lower ends in the core width direction is greater than the height (H) in the height direction, a clockwise closure domain structure and a magnetic domain structure that is a combination of closure domain structures may appear in the lower shield 12 and the upper shield 14 as shown in FIG. 8A and FIG. 8B. When looking from the magnetoresistance effect element 10, the lower shield 12 and the upper shield 14 are equivalent to a leftward magnetizing body in the case shown in FIG. 8A and equivalent to a rightward magnetizing body in the case shown in FIG. 8B.

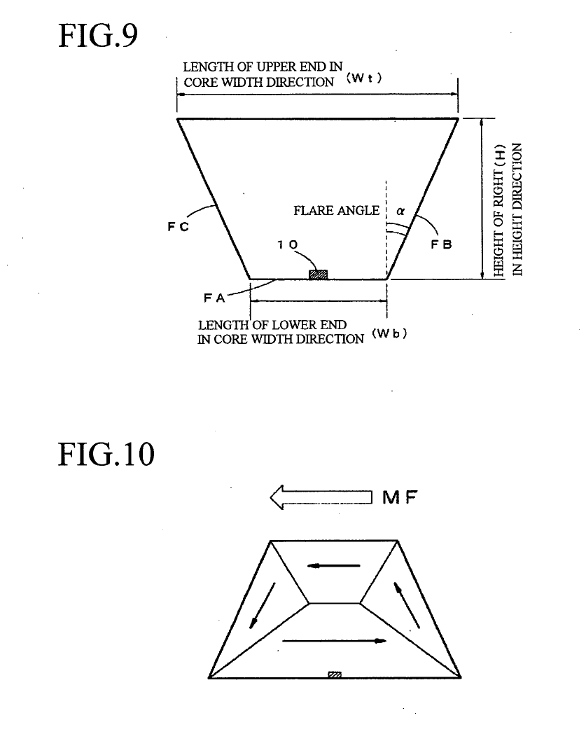

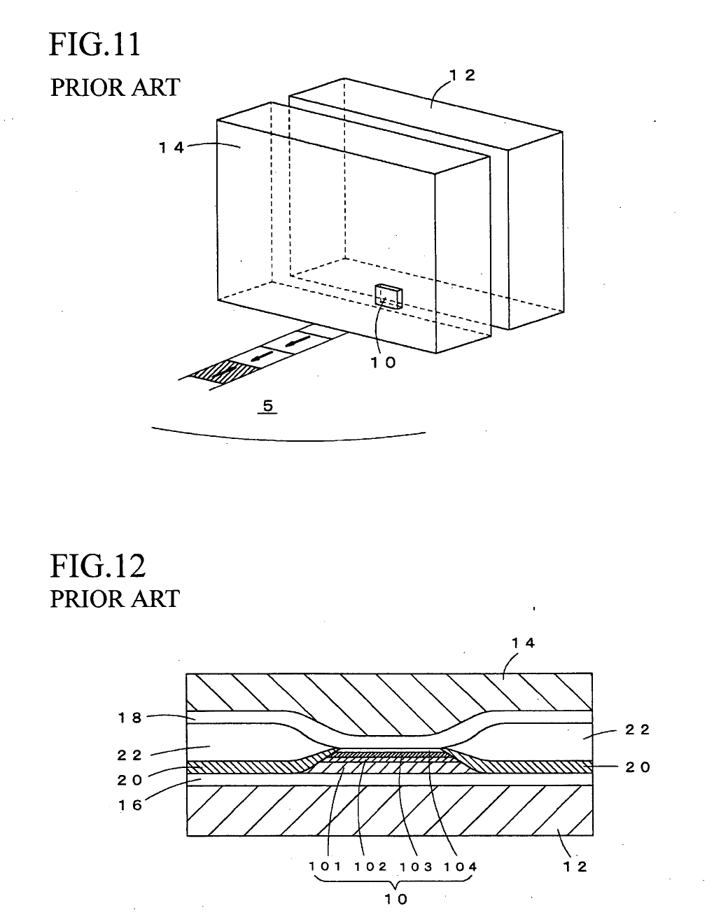

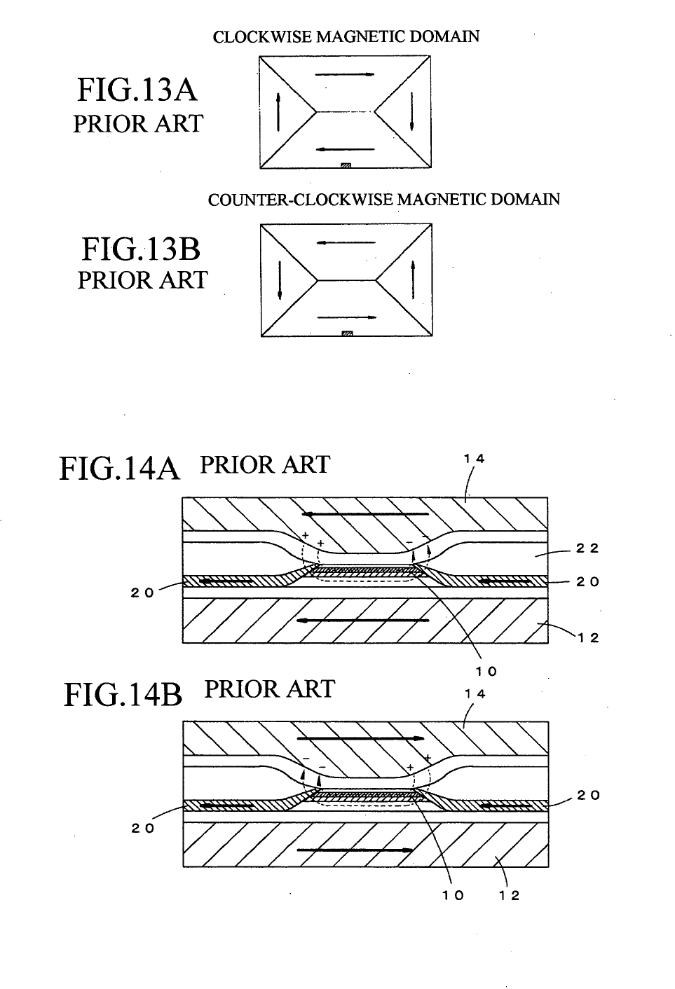

FIG. 9 is a diagram showing the planar shapes of the lower shield 12 and the upper shield 14.

If, as shown in FIGS. 8A and 8B, magnetic domain structures producing magnetic fields that act on the magnetoresistance effect element 10 in opposite directions may appear when the magnetizing magnetic field that acts on the lower shield 12 and the upper shield 14 has been removed, the bias magnetic field that acts on the magnetoresistance effect element 10 will not be constant and the head output will fluctuate.

Accordingly, the length (Wb) in the core width direction of the lower ends needs to be reduced to a certain length or below. In reality, by setting the length (Wb) in the core width direction of the lower ends in a range of one to three times the height (H) in the height direction, inclusive, the magnetic domain structure of the lower shield 12 and the upper shield 14 can be uniquely determined as the clockwise magnetic domain structure shown in FIG. 7.

If the flare angle made between the lower end surfaces FA and the first side surfaces FB in the height direction and the second side surfaces FC in the height direction of the lower shield 12 and the upper shield 14 is set as α, when the flare angle is below 10°, the lower shield 12 and the upper shield 14 are insufficiently asymmetrical, so that the magnetic domain structure that appears in the lower shield 12 and the upper shield 14 will not be uniquely determined. Conversely, when the angle θ is above 45°, further magnetic domains appear in triangular regions at both ends, which changes the entire magnetic domain structure of the lower shield 12 and the upper shield 14, so that the magnetic direction in the periphery of the magnetoresistance effect element 10 becomes unstable. Accordingly, in the present embodiment, the flare angle α between the lower end surface and the first side surface FB in the height direction and the second side surface FC in the height direction of the upper shield 14 should be in a range of around 10 to 45°, inclusive.

FIG. 6 to FIG. 9 show the case where the length (Wt) in the core width direction of the upper end is longer than the length (Wb) in the core width direction of the lower end, but as shown in FIG. 10, even when the length (Wt) in the core width direction of the upper end is shorter than the length (Wb) in the core width direction of the lower end, the magnetic domain structure can be uniquely determined due to the asymmetry of the planar shapes of the lower shield 12 and the upper shield 14. As shown in FIG. 10, when the length (Wt) in the core width direction of the upper end is longer than the length (Wb) in the core width direction of the lower end, a counter-clockwise closure domain structure appears in the lower shield 12 and the upper shield 14. In this case, the magnetic field shown in FIG. 14(b) acts on the magnetoresistance effect element 10.

It should be noted that in the above embodiment, the planar forms of the lower shield 12 and the upper shield 14 are isosceles trapezoids, but as the method of making the lower shield 12 and the upper shield 14 asymmetrical in the core width direction, it is not necessary to use isosceles trapezoids, and the first side surface FB and the second side surface FC in the height direction can be simply formed as inclined surfaces. Also, the flare angle α for one out of the first side surfaces FB and the second side surfaces FC can be set at 0°.

As described above, the present invention is characterized in that the lower shield 12 and the upper shield 14 disposed on both sides of the magnetoresistance effect element 10 in a magnetoresistance effect reproduction head have asymmetrical planar surfaces, so that when a magnetizing process is carried out during the manufacturing of the magnetoresistance effect reproduction head, the magnetic domain structure produced in the lower shield 12 and the upper shield 14 is uniquely determined as a specified magnetic domain structure.

Accordingly, the present invention is not limited to the spin-valve GMR element described above, and can be applied in exactly the same way to any magnetoresistance effect reproduction head including the lower shield 12 and the upper shield 14, such as an MR element, a TMR element, and a CPP-type GMR element. By uniquely determining the magnetic domain structure of the lower shield 12 and the upper shield 14, it is possible to prevent fluctuations in the head output due to the magnetic domain structure of the lower shield 12 and the upper shield 14 being indefinite.

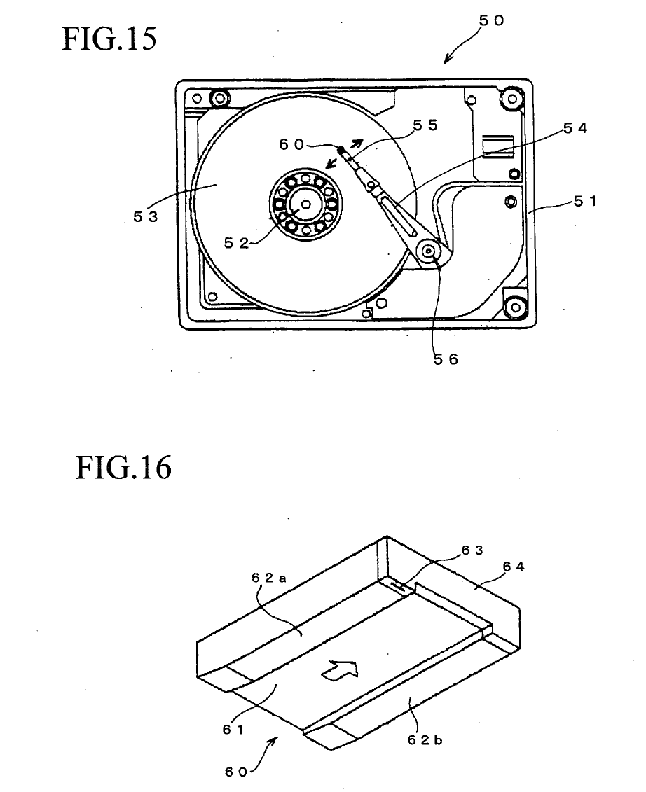

FIG. 15 shows one example of a magnetic disk apparatus that uses a recording/reproduction head including the magnetoresistance effect reproduction head described above. A magnetic disk apparatus 50 includes a plurality of magnetic recording disks 53 that are rotationally driven by a spindle motor 52 inside a casing 51 in the form of a rectangular box. Carriage arms 54 that are supported so as to be able to swing parallel to the disk surfaces are disposed beside the magnetic recording disks 53. Head suspensions 55 are attached to the ends of the carriage arms 54 so as to extend the carriage arms 54 and head sliders 60 are attached to the ends of the head suspensions 55. The head sliders 60 are attached to the surfaces of the head suspensions 55 that face the respective disk surfaces.

FIG. 16 is a perspective view of one of the head sliders 60. Floating rails 62a, 62b for causing the head slider 60 to float above the magnetic disk surface are provided along the side edges of a slider main body 61 on a surface (the ABS surface) of the head slider 60 that faces a magnetic disk. A recording/reproduction head 63 including a magnetoresistance effect head is disposed facing the magnetic disk at a front end (the side at which an air current flows out) of the head slider 60. The recording/reproduction head 63 is covered and protected by a protective film 64.

Each head slider 60 is elastically pressed toward a disk surface by the head suspension 55 and contacts the disk surface when rotation of the magnetic recording disks 53 is stopped. When the magnetic recording disks 53 are rotationally driven by the spindle motor 52, the respective head sliders 60 are caused to float by air currents produced by the rotation of the magnetic recording disks 53 and so move away from the respective disk surfaces.

Information is recorded onto a magnetic recording disk 53 and information is reproduced by the recording/reproduction head 63 provided on the head slider 60 by an operation (a seek operation) that swings the carriage arm 54 to a predetermined position using an actuator 56.

What is claimed is:

1. A magnetoresistance effect reproduction head comprising a shield part that magnetically shields a magnetoresistance effect element,
wherein the shield part is formed with a polygonal planar form that is asymmetrical in a height direction.

2. A magnetoresistance effect reproduction head according to claim 1,
wherein the shield part is formed so as to be trapezoidal where an upper end surface in the height direction is inclined.

3. A magnetoresistance effect reproduction head according to claim 1,
wherein an angle of inclination θ of the upper surface of the shield part is in a range of 10 to 45°, inclusive.

4. A magnetoresistance effect reproduction head according to claim 3,
wherein a length of the shield part in the height direction is set in a range of ⅕ to ⅔, inclusive, of a length of the shield part in a core width direction.

5. A magnetoresistance effect reproduction head including a shield part that magnetically shields a magnetoresistance effect element,
wherein the shield part is formed with a polygonal planar form that is asymmetrical in a core width direction.

6. A magnetoresistance effect reproduction head according to claim 5,
wherein the shield part is formed so as to be trapezoidal where side surfaces along a height direction are formed as inclined surfaces.

7. A magnetoresistance effect reproduction head according to claim 6,
wherein the shield part is formed with an isosceles trapezoidal planar form.

8. A magnetoresistance effect reproduction head according to either claim 6 or claim 7,
wherein a flare angle α of the side surfaces along the height direction of the shield part is set in a range of 10 to 45°, inclusive.

9. A magnetoresistance effect reproduction head according to claim 8,
wherein a height (H) of the shield part in the height direction is one to three times a width (Wb) of the shield part in the core width direction.

10. A magnetoresistance effect reproduction head according to claim 6,
wherein a flare angle of one side surface along the height direction of the shield part is 0°.

11. A magnetic disk apparatus including a magnetic recording disk that is rotationally driven by rotational driving means, support means including a head suspension and a carrier arm that support a head slider on which a recording/reproduction head is formed, and a control unit that drives the support means to cause the head slider to carry out a seek operation,
wherein the recording/reproduction head includes, as a reproduction head, a magnetoresistance effect reproduction head comprising a shield part that magnetically shields a magnetoresistance effect element, wherein the shield part is formed with a polygonal planar form that is asymmetrical in a height direction.

12. A magnetic disk apparatus including a magnetic recording disk that is rotationally driven by rotational driving means, support means including a head suspension and a carrier arm that support a head slider on which a recording/reproduction head is formed, and a control unit that drives the support means to cause the head slider to carry out a seek operation,
wherein the recording/reproduction head includes, as a reproduction head, a magnetoresistance effect reproduction head comprising a shield part that magnetically shields a magnetoresistance effect element, wherein the shield part is formed with a polygonal planar form that is asymmetrical in a core width direction.
